(19) United States
(12) Patent Application Publication
(10) Pub. No.: US 2022/0148565 A1
(43) Pub. Date: May 12, 2022

(54) READ IT!!

(71) Applicant: IMOGEAN SHY, MORRISVILLE, PA (US)

(72) Inventor: IMOGEAN SHY, MORRISVILLE, PA (US)

(21) Appl. No.: 17/472,673

(22) Filed: Oct. 20, 2021

Related U.S. Application Data
(60) Provisional application No. 63/204,221, filed on Sep. 21, 2020.

(51) Int. Cl. G10L 13/08; H04N 1/00; G06F 40/263

(52) U.S. Cl. CPC G10L 13/086; H04N 1/00331; H04N 1/00525; G06F 40/263; H04N 1/00488

(57) ABSTRACT

This present invention is to do exactly what it's called. It reads mail, letters and any paper correspondence for those individuals I described in the beginning of the specification. This invention is lightweight and portable and has headphone accessibility for privacy, which makes it easy to read your mail and letters anywhere. You just simply place the letters into input tray push play button and the machine reads it. As it is being read it slowly comes out of the bottom on the output tray.

This present invention is to assist an individual with reading. It is used as a reading tools to those who can't read well, who has eye or vision problems. But it's main purpose is to help those who are illiterate. Illiteracy is a world wide problem today.

### SUMMARY OF INVENTION

The objective of this invention is to provide a device/machine that has the capability to read mail, letters brochures, etc. It will make it a lot easier for those individuals to read their mail anywhere and anytime. It is a portable, lightweight device with headphone accessibility for privacy.

As a medical Secretary I've had to assist many patients with reading their letters and other papers. This invention was given to me by the inspiration of God. I had so much compassion for the patients some of them were illiterate, some had eye and vision problems and others didn't trust their loved one to read it.

### BRIEF DESCRIPTION OF DRAWINGS

FIG. 1 is the top and front of Read IT!! Showing the basic parts

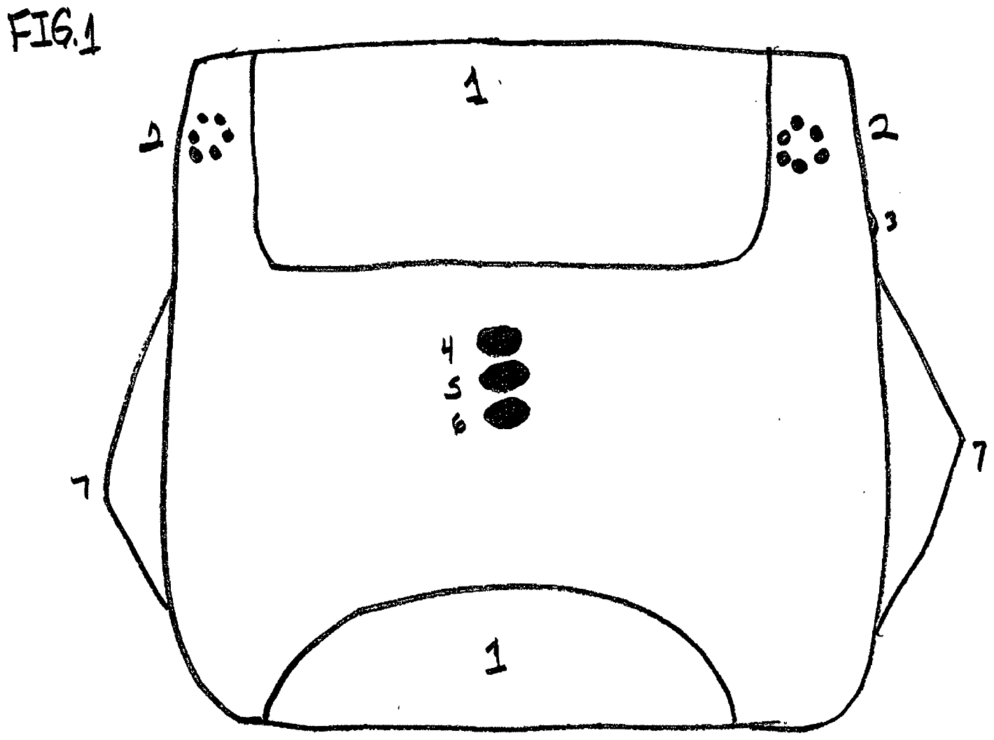

1 Adjustable input/Out paper tray, 2 Speakers, 3 Microphone/Charger input, 4 Read Button, 5 Volume Button, 6 Reverse/Repeat Button, 7 Flexible Stands

FIG. 2 is the bottom of Read IT!! Showing the basic parts

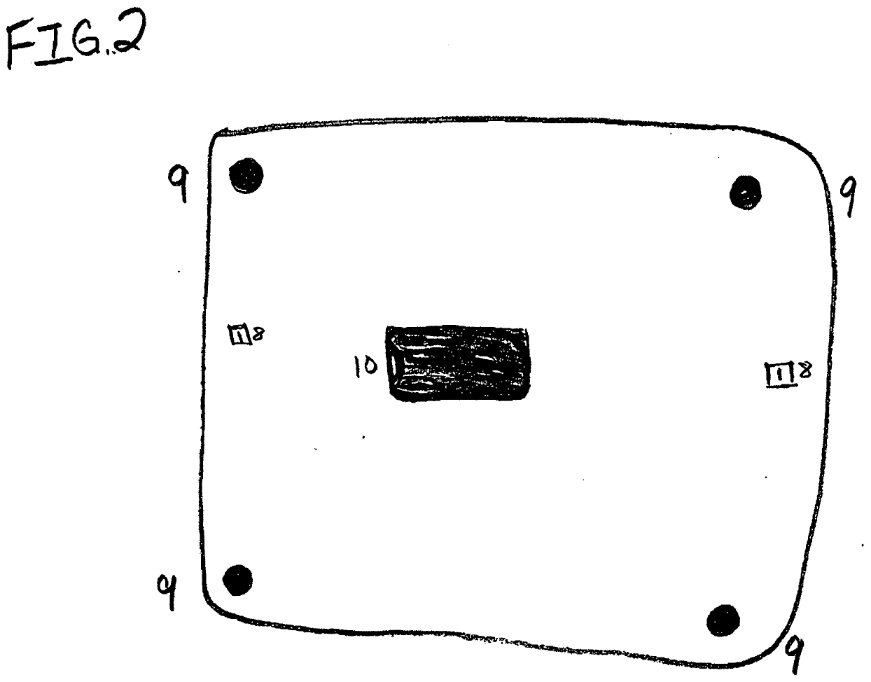

8 Flexible folding stands 9 4 Rubber Table Grips (prevent sliding), 10 Battery Compartment (4 AA)

1. A small portable device/ machine that reads mail, letters, and other paper correspondence.

2. it has front speakers,

3. headphone and charger jack,

4. It has 3 buttons in front center read, volume and reverse/ repeat.

5. also has Flexible folding stands one on each side.

6. On the back it has 4 rubber grips to prevent sliding, a battery compartment which holds 4 A batteries.

7. It has a small clamp to fit the two flexible folding stands.
